(19) United States
(12) Patent Application Publication
(10) Pub. No.: US 2026/0172795 A1
(43) Pub. Date: Jun. 18, 2026

(54) DOWNLOADING APPLICATIONS INTO VEHICLE VIA MOBILE TERMINAL

(71) Applicant: TOYOTA JIDOSHA KABUSHIKI KAISHA, Aichi-ken (JP)

(72) Inventors: Keisuke SAWADA, Tokyo-to (JP); Mitsuo Date, Funabashi-shi (JP); Shotato Yamaguchi, Yokohama-shi (JP)

(21) Appl. No.: 18/983,172

(22) Filed: Dec. 16, 2024

(51) Int. Cl. H04W 4/44; H04W 52/02

(52) U.S. Cl. CPC H04W 4/44; H04W 52/0238

(57) ABSTRACT

Downloading applications into vehicle via mobile terminal is performed by receiving, by a mobile computing network in a vehicle, a download request for an application; determining whether the mobile computing network is in communication with a mobile terminal capable of transmitting the application to the vehicle; instructing the mobile terminal to transmit the application to the mobile computing network in response to determining that the mobile computing network is in communication with the mobile terminal; and receiving, by the mobile computing network in a vehicle, the application from the mobile terminal.

### BACKGROUND

Modern vehicles are becoming increasingly connected with external systems (e.g., cloud servers, traffic management systems, other vehicles, etc.) via wireless technologies like cellular networks, Wi-Fi, and satellite links. In modern connected vehicles, data comes from multiple sources and is used for various purposes, ranging from safety-critical functions to improving the user experience.

### BRIEF DESCRIPTION OF THE DRAWINGS

Aspects of the present disclosure are best understood from the following detailed

description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for downloading applications into vehicle via mobile terminal, according to at least one embodiment of the subject disclosure.

FIG. 2 is an operational flow for downloading applications into vehicle via mobile terminal, according to at least one embodiment of the subject disclosure.

FIG. 3 is an operational flow for pausing and resuming download from mobile terminal, according to at least one embodiment of the subject disclosure.

FIG. 4 is a block diagram of a hardware configuration for downloading applications into vehicle via mobile terminal, according to at least some embodiments of the subject disclosure.

### DETAILED DESCRIPTION

The following disclosure provides many different embodiments, or examples, for

implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

When multiple types of data need to be downloaded, being able to perform downloads through mobile terminal enables the most important and time-sensitive data to get delivered and the communication between the vehicle and mobile network remain uninterrupted, which contributes to maintaining safety, functionality, and efficiency. The ability to manage this data flow effectively is central to the performance and safety of advanced vehicle systems. The connectivity between modern vehicles with external servers via wireless technologies allows vehicles to receive real-time information, such as: navigation data (e.g., map data, route search results, surrounding information), traffic condition data (e.g., congestion reports, accident alerts), remote operation data and diagnostics (e.g., key lock/unlock, air conditioner on/off, alarm activation, battery status, vehicle health checks), software updates (e.g., for infotainment systems, safety features, autonomous driving software), weather data (e.g., forecasts for route planning), user-specific data related to vehicle management (e.g., settings for seats, mirrors, climate control, account authentication, database of voice recognition), entertainment data (e.g., music, video, image, web search), as well as emergency related data (e.g., emergency call, security patch). However, downloading multiple types of data at once can strain a vehicle's connectivity and processing resources, and affect the communication between the vehicle and the mobile computing network. For example, if an application is downloaded to a vehicle using a mobile network communication device of the vehicle, the communication capability of the vehicle through the mobile network is reduced and thus communication between the vehicle and the mobile computing network may be interrupted. Therefore, allowing the user to download data into vehicle through mobile terminal is beneficial in enabling important updates to be processed in time, so that communications between the vehicle and the mobile computing network remains uninterruptable, and the vehicle remains safely and efficiently operable.

In at least some embodiments described herein, the solution to the above-mentioned problem is to allow users to download data into vehicle via mobile terminal. That is, when a user requests a download of an application to a vehicle, the application data is transmitted from the server to the vehicle via a mobile terminal of the user. The communication between the mobile terminal and the vehicle includes short-distance technologies, such as Bluetooth, Wifi, USB, Ethernet, etc. By downloading data into vehicle via mobile terminal, the users are able to download an application using the vehicle internal communication device(s) without using the vehicle external communication device, leaving the connection to the mobile network free and uninterrupted.

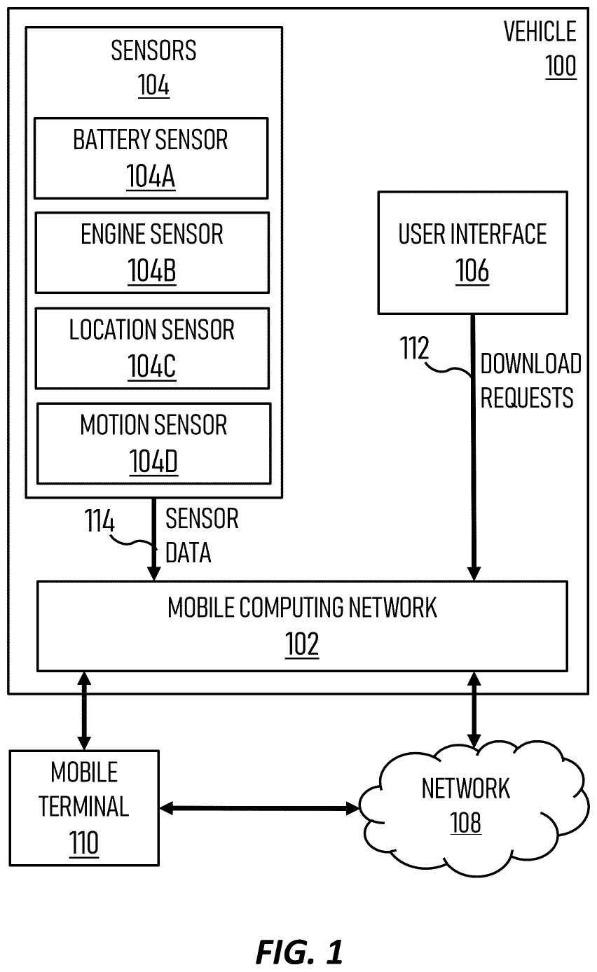

FIG. 1 is a schematic diagram of a system for downloading applications into vehicle via mobile terminal, according to at least one embodiment of the subject disclosure. The system includes a plurality of sensors 104, and a user interface 106 connected to a mobile computing network 102 within a vehicle 100. Vehicle 100 is further in communication with a mobile terminal 110 and a network 108 through mobile computing network 102. Sensors 104 include a battery sensor 104A, an engine sensor 104B, a location sensor 104C and a motion sensor 104D. Sensors 104 are configured to transmit sensor data 114 to mobile computing network 102. Mobile terminal 110 is in communication with network 108. User interface 106 is configured to transmit download requests 112 to mobile computing network 102. In at least some embodiments, mobile computing network 102, sensors 104, and user interface 106 are parts of a single device, such as vehicle 100.

In at least some embodiments, vehicle 100 is configured to transmit notifications and instructions to mobile terminal 110, and to receive an application from mobile terminal 110. In at least some embodiments, vehicle 100 is in communication with mobile terminal 110 through mobile computing network 102. In at least some embodiments, vehicle 100 is in communication with mobile terminal 110 through network 108. In at least some embodiments, vehicle 100 is an automobile or an autonomous vehicle.

In at least some embodiments, mobile computing network 102 is configured to receive download requests 112 from user interface 106, and to receive sensor data 114 from sensors 104. In at least some embodiments, mobile computing network 102 is configured to receive notifications. In at least some embodiments, mobile computing network 102 is configured to receive permissions and instructions. In at least some embodiments, mobile computing network 102 is configured to perform downloads of download requests 112. In at least some embodiments, mobile computing network 102 is in communication with mobile terminal 110. In at least some embodiments, mobile computing network 102 is configured to receive applications from mobile terminal 110. In at least some embodiments, mobile computing network 102 is configured to deny reception of applications from mobile terminal 110. In at least some embodiments, mobile computing network 102 is an integration of wireless communication technologies and computing systems within vehicle 100 to support a variety of connected services, applications, and functions. In at least some embodiments, mobile computing network 102 is configured to enable vehicle 100 to interact with external systems (e.g., the internet, cloud services, other vehicles, or infrastructure), as well as support on-board systems that enhance the driving experience, safety, navigation, and overall functionality of vehicle 100. In at least some embodiments, mobile computing network 102 is a Controller Area Network (CAN), an Ethernet, a Peripheral Component Interconnect Express (PCIe) network, a Universal Serial Bus (USB) network, or a Local Internet Network (LIN). In at least some embodiments, mobile computing network 102 includes short-distance technologies, such as Bluetooth network, USB network, etc.

Sensors 104 are configured to transmit sensor data 114 to mobile computing network 102. Sensors 104 include battery sensor 104A, engine sensor 104B, location sensor 104C and motion sensor 104D. In at least some embodiments, data types of sensor data 114 provided by battery sensor 104A, engine sensor 104B, location sensor 104C and motion sensor 104D are different. In at least some embodiments, battery sensor 104A is configured to detect a remaining capacity of a vehicle battery. In at least some embodiments, battery sensor 104A is configured to detect whether a charging operation is applied to the vehicle battery. In at least some embodiments, battery sensor 104A is configured to detect whether vehicle 100 is in a power saving mode. In at least some embodiments, engine sensor 104B is configured to detect if vehicle 100 is in a power-on state or a power-off state. In at least some embodiments, location sensor 104C is configured to detect the geographic location of vehicle 100. In at least some embodiments, location sensor 104C is configured to determine a precise position, orientation, and movement of vehicle 100 in real-time. In at least some embodiments, location sensor 104C is a GPS (Global Positioning System), an accelerometer, a gyroscope, a compass, etc. In at least some embodiments, motion sensor 104D is configured to detect a vehicle state of vehicle 100. In at least some embodiments, the vehicle state indicates whether vehicle 100 is running or stopped. In at least some embodiments, motion sensor 104D is configured to detect and measure the movement or acceleration of vehicle 100. In at least some embodiments, motion sensor 104D is configured to measure acceleration, angular velocity, and directional changes of vehicle 100. In at least some embodiments, motion sensor 104D is an accelerometer, a gyroscope, an Inertial Measurement Unit (IMU), a radar sensor, or a camera-based system.

User interface 106 is configured to transmit download requests to mobile computing network 102. In at least some embodiments, user interface 106 is configured to enable drivers, passengers, and other users to interact with the vehicle's various systems, technologies, and features. In at least some embodiments, user interface 106 is a touchscreen display, a voice control system, a Heads-Up Display (HUD), a gesture control, a smartphone, or a mobile integration and connectivity system. In at least some embodiments, user interface 106 is external to the vehicle.

Network 108 is configured to enable communications between mobile terminal 110 and mobile computing network 102 of vehicle 100. In at least some embodiments, network 108 is configured to connect vehicle 100 with external systems, other vehicles, or the cloud. In at least some embodiments, network 108 is configured to enable real-time data exchange, remote diagnostics, entertainment features, and advanced driver assistance systems (ADAS). In at least some embodiments, network 108 is a wired network, a 4G LTE network, a 5G network, or a Wi-Fi network that allows Vehicle-to-Vehicle (V2V) communication or Vehicle-to-Everything (V2X) communication. In at least some embodiments, network 108 includes short-distance technologies, such as Bluetooth network, Ethernet, USB network, etc.

Mobile terminal 110 is configured to communicate with vehicle 100 through mobile computing network 102 or network 108. In at least some embodiments, mobile terminal 110 is configured to receive notifications from vehicle 100. In at least some embodiments, mobile terminal 110 is configured to transmit applications to vehicle 100. In at least some embodiments, mobile terminal 110 is a portable device that is configured to connect to networks and exchange data. In at least some embodiments, mobile terminal 110 is a smartphone, a tablet, a smartwatch, a portable laptop, or smart glasses.

Download requests 112 are transmitted by user interface 106 to mobile computing network 102. In at least some embodiments, download requests 112 include requests for downloading applications or data related to operating system updates, entertainment, navigation, vehicle management, security and emergency, etc. In at least some embodiments, entertainment data includes music data, video data, and image data, etc. In at least some embodiments, navigation data includes map data, route search result data (if route search is performed in a server), surrounding information, and traffic conditions, etc. In least some embodiments, vehicle management data includes key lock/unlock, air conditioner on/off, and alarm activation, etc. In at least some embodiments, security data includes security patches. In at least some embodiments, emergency data includes emergency calls. In at least some embodiments, download requests 112 include requests for downloading applications or data related to web searches, account authentications, and database of voice recognitions, etc.

Sensor data 114 is transmitted by sensors 104 to mobile computing network 102. In at least some embodiments, sensor data 114 includes data of different data types, which are detected by different sensors of sensors 104. In at least some embodiments, the types of data are different depending on the sensor design. In at least some embodiments, sensor data 114 includes vehicle battery status data, vehicle state data, geographic location data, etc.

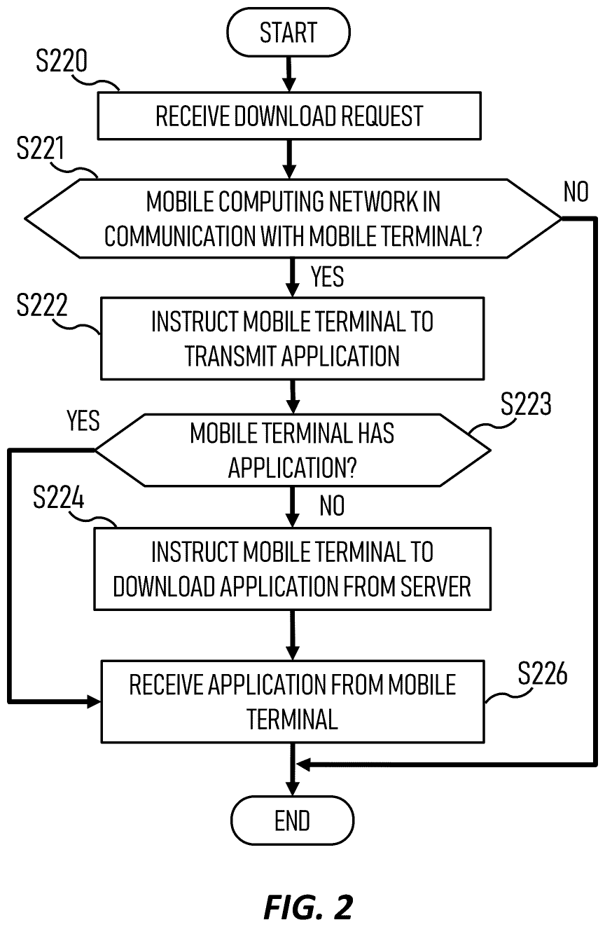

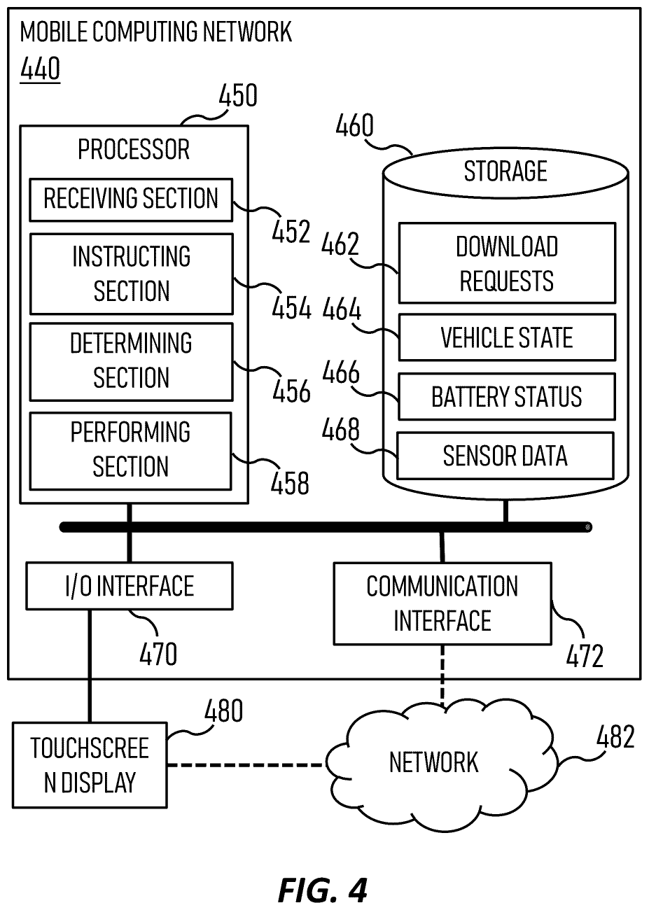

FIG. 2 is an operational flow for downloading applications into a vehicle via a mobile terminal, according to at least one embodiment of the subject disclosure. The operational flow provides a method of downloading applications into a vehicle via a mobile terminal. In at least some embodiments, the method is performed by a vehicle, such as vehicle 100 shown in FIG. 1, or a processor of an integrated circuit including sections for performing certain operations, such as the processor 450 shown in FIG. 4, which will be explained hereinafter.

At S220, a receiving section of the processor receives a download request. In at least some embodiments, the receiving section of a mobile computing network in a vehicle receives a download request for an application. In at least some embodiments, when requesting an application, the user can request download of the application data to either the vehicle or a mobile terminal via a user interface. In at least some embodiments, the receiving section receives the download request for downloading applications related to entertainment, navigation, vehicle management, security and emergency.

At S221, a determining section determines whether the mobile computing network is in communication with the mobile terminal. In at least some embodiments, the determining section determines whether the mobile computing network is in communication with a mobile terminal capable of transmitting the application to the vehicle. In response to the processor determining that the mobile computing network is in communication with the mobile terminal, the operational flow proceeds to instructing mobile terminal to transmit the application at S222. In response to the processor determining that the mobile computing network is not in communication with the mobile terminal, the operational flow ends.

At S222, an instructing section thereof instructs the mobile terminal to transmit the application. In at least some embodiments, the instructing section instructs the mobile terminal to transmit the application to the mobile computing network in response to determining that the mobile computing network is in communication with the mobile terminal. In at least some embodiments, the instructing section instructs the mobile terminal to indicate transmission of the application to the mobile computing network through at least one of a display, a speaker, or a vibrator. In at least some embodiments, during communication between the server and the mobile terminal on behalf of the vehicle, a notification that data is being transmitted from the server to the mobile terminal is indicated on the mobile terminal through a display, speaker, or haptic-feedback, etc. In at least some embodiments, during communication between the mobile terminal and the vehicle, a notification that data is being transmitted from the mobile terminal to the vehicle is indicated on the mobile terminal through a display, speaker, or haptic-feedback, etc. In at least some embodiments, the mobile terminal receives the indication through a mobile computing network of the vehicle or a network.

At S223, a determining section determines whether the mobile terminal has the application. In at least some embodiments, the determining section determines whether the mobile terminal has the application. In at least some embodiments, if an application requested by the user has already been installed in the mobile terminal, the application data is transmitted from the mobile terminal to the vehicle without transmitting the application data from the server to the mobile terminal. In response to the processor determining that the mobile terminal has the application, the operational flow proceeds to receiving the application from the mobile terminal at S226. In response to the processor determining the mobile terminal does not have the application, the operational flow proceeds to instructing the mobile terminal to download the application from a server at S224.

At S224, the instructing section instructs the mobile terminal to download the application from the server. In at least some embodiments, the instructing section instructs the mobile terminal to download the application from a server in response to determining that the mobile terminal does not have the application.

At S226, the receiving section receives the application from the mobile terminal. In at least some embodiments, the receiving section receives, by the mobile computing network in a vehicle, the application from the mobile terminal. In at least some embodiments, the receiving section intermittently receives data of the application from the mobile terminal. In at least some embodiments, before an application is entirely transmitted from the server to the mobile terminal, data is transmitted intermittently from the mobile terminal to the vehicle, which enables higher throughput compared to the method of transmitting data from the mobile terminal to the vehicle after the application is entirely transmitted from the server to the mobile terminal. In at least some embodiments, the mobile terminal is configured to download the application completely, then transmit the application completely, or download and transmit intermittently, depending on a user setting, or automatically selected based on an estimation of throughput. In at least some embodiments, when the user requests download of an application to a vehicle and a mobile terminal, the application is installed in the mobile terminal first, and then the application is installed in the vehicle by transmitting the application data from the mobile terminal to the vehicle. In at least some embodiments, if the user requests download of an application to the mobile terminal that has already been installed in the vehicle, then the application data is transmitted from the vehicle to the mobile terminal.

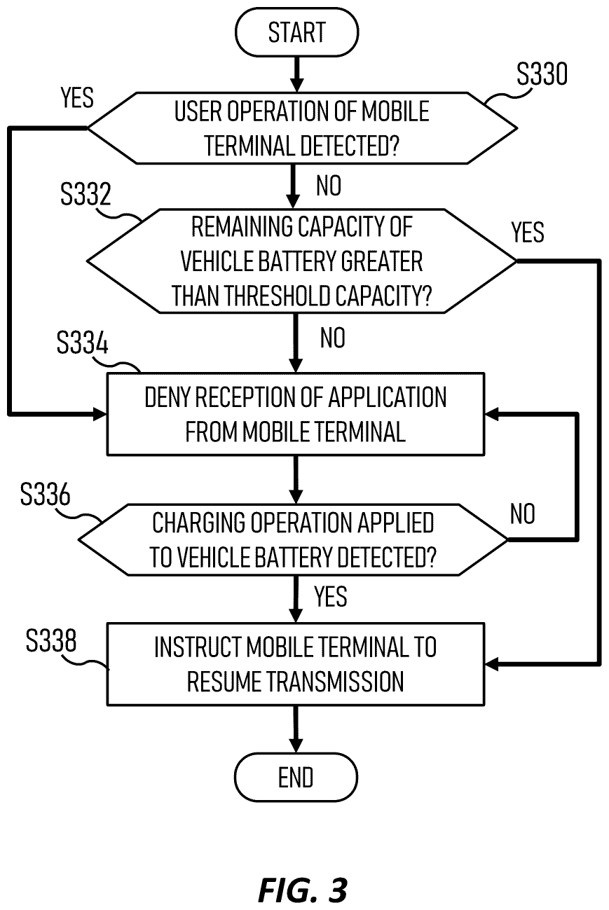

FIG. 3 is an operational flow for pausing and resuming download from the mobile terminal, according to at least one embodiment of the subject disclosure. The operation flow provides a method of pausing and resuming download from the mobile terminal. In at least some embodiments, the method is performed by a vehicle, such as vehicle 100 shown in FIG. 1, or a processor of an integrated circuit including sections for performing certain operations, such as the processor 450 shown in FIG. 4, which will be explained hereinafter.

At S330, the determining section determines whether user operation of the mobile terminal is detected. In at least some embodiments, the determining section determines whether user operation of the mobile terminal is detected. In at least some embodiments, the processor or a section thereof detects user operation of the mobile terminal. In response to the processor determining that user operation of the mobile terminal is detected, the operational flow proceeds to denying reception of the application from the mobile terminal at S334. In response to the processor determining that user operation of the mobile terminal is not detected, the operational flow proceeds to determining whether a remaining capacity of the vehicle battery is greater than a threshold capacity at S332.

At S332, the determining section determines whether the remaining capacity of the vehicle battery is greater than the threshold capacity. In at least some embodiments, the determining section determines whether the remaining capacity of the vehicle battery is greater than the threshold capacity. In at least some embodiments, the processor or a section thereof detects a remaining capacity of a vehicle battery. In response to the processor determining that the remaining capacity of the vehicle battery is greater than the threshold capacity, the operational flow proceeds to instructing the mobile terminal to resume transmission at S338. In response to the processor determining that the remaining capacity of the vehicle battery is not greater than the threshold capacity, the operational flow proceeds to denying reception of the application from the mobile terminal at S334.

At S334, a performing section denies reception of the application from the mobile terminal. In at least some embodiments, the performing section of the mobile computing network denies reception of the application from the mobile terminal in response to detecting user operation of the mobile terminal. In at least some embodiments, an optional user setting enables the vehicle to prohibit transmission through the mobile terminal while the user is operating the mobile terminal, which can be enforced by prohibiting transmission of the application from the server to the mobile terminal, prohibiting transmission of the application from the mobile terminal to the vehicle, or both. In at least some embodiments, the performing section of the mobile computing network denies reception of the application from the mobile terminal in response to detecting that the remaining capacity of the vehicle battery is not greater than a threshold capacity. In at least some embodiments, an optional user setting enables the vehicle to prohibit transmission through the mobile terminal while a remaining capacity of a battery of the mobile terminal is equal to or less than a predetermined value, which can be enforced by prohibiting transmission of the application from the server to the mobile terminal, prohibiting transmission of the application from the mobile terminal to the vehicle, or both.

At S336, the determining section determines whether a charging operation applied to the vehicle battery is detected. In at least some embodiments, the processor or a section thereof detects a charging operation applied to the vehicle battery after determining that the remaining capacity is not greater than the threshold capacity. In response to the determining section determining that the charging operation applied to the vehicle battery is detected, the operational flow proceeds to instructing the mobile terminal to resume transmission at S338. In response to the processor determining that no charging operation applied to the vehicle battery is detected, the operational flow returns to denying reception of the application from the mobile terminal at S334.

At S338, the instruction section instructs the mobile terminal to resume transmission. In at least some embodiments, the instructing section instructs the mobile terminal to resume transmission of the application to the mobile computing network in response to detecting the charging operation. In at least some embodiments, an optional user setting enables the vehicle to disregard prohibition based on battery capacity when the mobile terminal is being charged in the vehicle, allowing data transmission to proceed.

FIG. 4 is a block diagram of a hardware configuration for downloading applications into vehicle via mobile terminal, according to at least some embodiments of the subject disclosure.

The exemplary hardware configuration includes mobile computing network 440, which interacts with touchscreen display 480 directly or through network 482. In at least some embodiments, mobile computing network 440 is a network of a computer or other computing device of a vehicle that receives input or commands from touchscreen display 480. In at least some embodiments, mobile computing network 440 is a computer system that executes computer-readable instructions to perform downloads based on priorities.

Mobile computing network 440 includes a processor 450, a storage unit 460, an input/output interface 470, and a communication interface 472. In at least some embodiments, processor 450 is a processor or programmable circuitry executing instructions to cause the processor or programmable circuitry to perform operations according to the instructions. In at least some embodiments, processor 450 includes analog or digital programmable circuitry, or any combination thereof. In at least some embodiments, processor 450 includes physically separated storage or circuitry that interacts through a protocol. In at least some embodiments, storage unit 460 includes a non-volatile computer-readable medium capable of storing executable and non-executable data for access by processor 450 during execution of the instructions. Communication interface 472 transmits and receives data from network 482. Input/output interface 470 connects to various input and output units, such as touchscreen display 480, via a parallel port, a serial port, a keyboard port, a mouse port, a monitor port, a touch screen, a connection with a mobile device and the like to accept commands and present information. In some embodiments, storage unit 460 is external from mobile computing network 440.

Processor 450 includes receiving section 452, instructing section 454, determining section 456 and performing section 458. Storage unit 460 includes download requests 462, vehicle state 464, battery status 466, and sensor data 468.

Receiving section 452 is the circuitry or instructions of processor 450 configured to receive a download request for an application. In at least some embodiments, receiving section 452 is configured to receive, by a mobile computing network in a vehicle, a download request for an application. In at least some embodiments, receiving section 452 is configured to receive, by the mobile computing network in a vehicle, the application from the mobile terminal. In at least some embodiments, receiving section 452 is configured to intermittently receive data of the application from the mobile terminal. In at least some embodiments, receiving section 452 utilizes information in storage unit 460, such as download requests 462. In at least some embodiments, receiving section 452 includes sub-sections for performing additional functions, as described in the foregoing flow charts. In at least some embodiments, such sub-sections are referred to by a name associated with a corresponding function.

Instructing section 454 is the circuitry or instructions of processor 450 configured to instruct the mobile terminal to transmit the application to the mobile computing network. In at least some embodiments, instructing section 454 is configured to instruct the mobile terminal to transmit the application to the mobile computing network in response to determining that the mobile computing network is in communication with the mobile terminal. In at least some embodiments, instructing section 454 is configured to instruct the mobile terminal to resume transmission of the application to the mobile computing network in response to detecting the charging operation. In at least some embodiments, instructing section 454 is configured to instruct the mobile terminal to indicate transmission of the application to the mobile computing network through at least one of a display, a speaker, or a vibrator. In at least some embodiments, instructing section 454 is configured to instruct the mobile terminal to download the application from a server in response to determining that the mobile terminal does not have the application. In at least some embodiments, instructing section 454 utilizes information in storage unit 460, such as download requests 462 and battery status 466. In at least some embodiments, instructing section 454 includes sub-sections for performing additional functions, as described in the foregoing flow charts. In at least some embodiments, such sub-sections are referred to by a name associated with a corresponding function.

Determining section 456 is the circuitry or instructions of processor 450 configured to determine whether the mobile computing network is in communication with a mobile terminal. In at least some embodiments, determining section 456 is configured to determine whether the mobile computing network is in communication with a mobile terminal capable of transmitting the application to the vehicle. In at least some embodiments, determining section 456 is configured to determine whether the remaining capacity of the vehicle battery is greater than the threshold capacity. In at least some embodiments, determining section 456 is configured to determine whether the mobile terminal has the application. In at least some embodiments, determining section 456 is configured to determine whether a charging operation is applied to the vehicle battery. In at least some embodiments, determining section 456 is configured to determine whether there is a user operation of the mobile terminal. In at least some embodiments, determining section 456 utilizes information in storage unit 460, such as download requests 462, vehicle state 464, battery status 466 and sensor data 468. In at least some embodiments, determining section 456 includes sub-sections for performing additional functions, as described in the foregoing flow charts. In at least some embodiments, such sub-sections are referred to by a name associated with a corresponding function.

Performing section 458 is the circuitry or instructions of processor 450 configured to perform downloads of the download requests. In at least some embodiments, performing section 458 is configured to deny, by the mobile computing network, reception of the application from the mobile terminal in response to detecting user operation of the mobile terminal. In at least some embodiments, performing section 458 is configured to deny, by the mobile computing network, reception of the application from the mobile terminal in response to detecting that the remaining capacity of the vehicle battery is not greater than a threshold capacity. In at least some embodiments, performing section 458 utilizes information in storage unit 460, such as download requests 462, vehicle state 464 and battery status 466. In at least some embodiments, performing section 458 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the processor and the storage unit need not be entirely separate devices, but share circuitry or one or more computer-readable mediums in some embodiments. In at least some embodiments, the storage unit includes a hard drive storing both the computer-executable instructions and the data accessed by the processor, and the processor includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a processor responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the subject disclosure.

While embodiments of the subject disclosure have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, downloading applications into vehicle via mobile terminal is performed by receiving, by a mobile computing network in a vehicle, a download request for an application; determining whether the mobile computing network is in communication with a mobile terminal capable of transmitting the application to the vehicle; instructing the mobile terminal to transmit the application to the mobile computing network in response to determining that the mobile computing network is in communication with the mobile terminal; and receiving, by the mobile computing network in a vehicle, the application from the mobile terminal.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A method comprising:
receiving, by a mobile computing network in a vehicle, a download request for an application;
determining whether the mobile computing network is in communication with a mobile terminal capable of transmitting the application to the vehicle;
instructing the mobile terminal to transmit the application to the mobile computing network in response to determining that the mobile computing network is in communication with the mobile terminal; and
receiving, by the mobile computing network in a vehicle, the application from the mobile terminal.

2. The method of claim 1, wherein the receiving the application includes intermittently receiving data of the application from the mobile terminal.

3. The method of claim 1, further comprising:
detecting user operation of the mobile terminal; and
denying, by the mobile computing network, reception of the application from the mobile terminal in response to detecting user operation of the mobile terminal.

4. The method of claim 1, further comprising:
detecting a remaining capacity of a vehicle battery; and
denying, by the mobile computing network, reception of the application from the mobile terminal in response to detecting that the remaining capacity of the vehicle battery is not greater than a threshold capacity.

5. The method of claim 4, further comprising:
detecting a charging operation applied to the vehicle battery after determining that the remaining capacity is not greater than the threshold capacity; and
instructing the mobile terminal to resume transmission of the application to the mobile computing network in response to detecting the charging operation.

6. The method of claim 1, further comprising instructing the mobile terminal to indicate transmission of the application to the mobile computing network through at least one of a display, a speaker, or a vibrator.

7. The method of claim 1, further comprising:
determining whether the mobile terminal has the application; and
instructing the mobile terminal to download the application from a server in response to determining that the mobile terminal does not have the application.

8. A device comprising:
a processor including circuitry configured to
receive, by a mobile computing network in a vehicle, a download request for an application;
determine whether the mobile computing network is in communication with a mobile terminal capable of transmitting the application to the vehicle;
instruct the mobile terminal to transmit the application to the mobile computing network in response to determining that the mobile computing network is in communication with the mobile terminal; and
receive, by the mobile computing network in a vehicle, the application from the mobile terminal.

9. The device of claim 8, wherein the processor receives the application includes the processor being configured to intermittently receive data of the application from the mobile terminal.

10. The device of claim 8, wherein the processor is further configured to:
detect user operation of the mobile terminal; and
deny, by the mobile computing network, reception of the application from the mobile terminal in response to detecting user operation of the mobile terminal.

11. The device of claim 8, wherein the processor is further configured to:
detect a remaining capacity of a vehicle battery; and
deny, by the mobile computing network, reception of the application from the mobile terminal in response to detecting that the remaining capacity of the vehicle battery is not greater than a threshold capacity.

12. The device of claim 11, wherein the processor is further configured to:
detect a charging operation applied to the vehicle battery after determining that the remaining capacity is not greater than the threshold capacity; and
instruct the mobile terminal to resume transmission of the application to the mobile computing network in response to detecting the charging operation.

13. The device of claim 8, wherein the processor is further configured to instruct the mobile terminal to indicate transmission of the application to the mobile computing network through at least one of a display, a speaker, or a vibrator.

14. The device of claim 8, wherein the processor is further configured to:
determining whether the mobile terminal has the application; and
instructing the mobile terminal to download the application from a server in response to determining that the mobile terminal does not have the application.

15. A non-transitory computer-readable medium having instructions recorded thereon that are executable by one or more processors to perform operations comprising:
receiving, by a mobile computing network in a vehicle, a download request for an application;
determining whether the mobile computing network is in communication with a mobile terminal capable of transmitting the application to the vehicle;
instructing the mobile terminal to transmit the application to the mobile computing network in response to determining that the mobile computing network is in communication with the mobile terminal; and
receiving, by the mobile computing network in a vehicle, the application from the mobile terminal.

16. The non-transitory computer-readable medium of claim 15, wherein the receiving the application includes intermittently receiving data of the application from the mobile terminal.

17. The non-transitory computer-readable medium of claim 15, wherein the operations further comprise:
detecting user operation of the mobile terminal; and
denying, by the mobile computing network, reception of the application from the mobile terminal in response to detecting user operation of the mobile terminal.

18. The non-transitory computer-readable medium of claim 15, wherein the operations further comprise:
detecting a remaining capacity of a vehicle battery; and
denying, by the mobile computing network, reception of the application from the mobile terminal in response to detecting that the remaining capacity of the vehicle battery is not greater than a threshold capacity.

19. The non-transitory computer-readable medium of claim 18, wherein the operations further comprise:
detecting a charging operation applied to the vehicle battery after determining that the remaining capacity is not greater than the threshold capacity; and
instructing the mobile terminal to resume transmission of the application to the mobile computing network in response to detecting the charging operation.

20. The non-transitory computer-readable medium of claim 15, wherein the operations further comprise instructing the mobile terminal to indicate transmission of the application to the mobile computing network through at least one of a display, a speaker, or a vibrator.
